(19) United States
(12) Patent Application Publication
(10) Pub. No.: US 2004/0118867 A1
(43) Pub. Date: Jun. 24, 2004

(54) Beverage container and support therefor

(76) Inventor: Cameron A Cote, Cochrane (CA)

Correspondence Address: Roseann B Caldwell, Bennett Jones, 4500 855-2nd Street S W, Calgary, AB, T2P 4K7, CA

(21) Appl. No.: 10/471,428

(22) PCT Filed: Mar. 15, 2002
(86) PCT No.: PCT/CA02/00364

(30) Foreign Application Priority Data
Mar. 15, 2001 (US) 09805993

(51) Int. Cl. B67D 5/00

(52) U.S. Cl. 222/88

(57) ABSTRACT

A beverage continer is described for use in a beverage dispenser having a beverage feed tube pin (52). The beverage container (1) has a wall (2) with an outer surface and an inner surface (2b) and which defines an inner chamber (3). An opening (4) is formed through the wall providing access to the inner chamber and is sized to permit the feed tube pin (52) to extend therethrough. The opening includes a seal (6) therein to substantially seal the opening against passage therethrough of liquid. The seal is selected to pass over the feed tube pin and substantially seal against passage of fluid through the interface between the opening and the feed tube pin. The seal is further selected to maintain its substantially sealing position in the opening as the feed tube pin (52) is removed therefrom. The container further includes an openable area (7) on the container, which is selectively openable to permit a passage of air therethrough into the inner chamber.

### FIELD OF THE INVENTION

The present invention is directed to a beverage container and, in particular, a beverage container for use in a beverage dispenser and a support therefor.

### BACKGROUND OF THE INVENTION

Beverage dispensers are known that dispense beverages from containers installed in the dispenser. A beverage container is needed that can be used in a dispenser and removed from the dispenser, even when containing liquid, without problematic spilling of the contents thereof into the dispenser.

### SUMMARY OF THE INVENTION

A beverage container has been invented that is useful in a beverage dispenser including a feed tube pin. The beverage container can safely and sanitarily transport the beverage contained therein and can be installed into the beverage dispenser to dispense the beverage contained therein. Once installed the container can be removed, even when containing some liquid, substantially without spilling its contents into the dispenser.

Thus, in accordance with a broad aspect of the present invention, there is provided a beverage container for use in a beverage dispenser having a beverage feed tube pin, the beverage container comprising: a wall having an outer surface and an inner surface and defining an inner chamber; an opening through the wall providing access to the inner chamber and sized to permit the feed tube pin to extend therethrough; a seal in the opening to substantially seal the opening against passage therethrough of liquid and selected to pass over the feed tube pin and substantially seal against passage of fluid through the interface between the opening and the feed tube pin, the seal further being selected to maintain its substantially sealing position in the opening as the feed tube pin is removed therefrom; and an openable area on the container, the openable area being selectively openable to permit a passage of air therethrough into the inner chamber.

In one embodiment, the opening is protected by a cap, which can be removed to provide access to the seal. In another embodiment, the opening has mounted thereover a cap having an aperture through which the seal can be accessed.

The seal can be formed in any way to seal the opening and between the opening and the feed tube pin. In one embodiment, the seal is elastomeric and selected to conform about the feed tube pin as it passes therethrough. Preferably, the seal is resilient to resume its sealing position once the feed tube pin is withdrawn from the opening. The seal can be puncturable or include an opening therein, such as a slit.

The container can further include a puncturable liner in the opening. In one embodiment, the liner is disposed adjacent the seal's inner facing side.

The openable area, is preferably disposed on the wall at an end of the container opposite the opening, which is generally adjacent the container base such that it is disposed in the air pocket above the liquid when the container is oriented with its opening substantially vertically below the openable area. The openable area can be spaced a selected distance from the base of the container. The distance is preferably selected such that the volume of the inner chamber between the base and the port formed or to be punctured in the openable area is sufficient to accommodate the volume of residual liquid remaining in the container when it is deemed to be completely used, which is generally less than 50 ml. In one embodiment, the distance is selected to be greater than 3 mm and preferably between 6 to 20 mm.

In one embodiment, the openable area includes a port through the wall and a removable or breakable seal over the port. In another embodiment, the openable area is puncturable to form a port therethrough. The port, being either formed during manufacture or by puncturing, can be oriented to open downwardly (i.e. toward the container opening) to prevent matter from dropping into the container through the port, when the container is installed on the feed tube pin.

In another embodiment, the container further includes a protrusion extending outwardly therefrom and the port is positioned in association with the protrusion on the wall such that the port is positioned beneath the protrusion when the container is installed on the feed tube pin. The port can be formed or puncturable in this position.

The container can further include a form that mates with a form on a container support in the dispenser that permits the container to be properly positioned in the dispenser. The form on the container can be a protrusion or an indentation.

In accordance with another broad aspect of the present invention, there is provided a beverage container support for supporting a beverage container including an opening for dispensing beverage therethrough and a base opposite the opening, the beverage container support comprising: a holder shaped to accept a beverage container; a feed tube pin extending upwardly in the holder and insertable into a beverage container to be supported; and a punch to puncture the beverage container when the beverage container is inserted over the feed tube pin and the punch spaced from the feed tube pin such that the punch acts adjacent the base of the beverage container.

In one embodiment, the punch is recessed and is driven out to puncturing position by installation of the beverage container to the support. In another embodiment, the holder is sized to have a volume selected to substantially contain the volume of the container. The holder can include a member mateable with a member on the container.

### BRIEF DESCRIPTION OF THE DRAWINGS

A further, detailed, description of the invention, briefly described above, will follow by reference to the following drawings of specific embodiments of the invention. These drawings depict only typical embodiments of the invention and are therefore not to be considered limiting of its scope. In the drawings:

FIG. 1 is a side elevation view of a concentrate container according to the invention;

FIG. 2 is a side elevation view of a concentrate container according to the invention;

FIG. 3 is a sectional view showing a container aligned for entry into a concentrate container support; and

FIG. 4 is a sectional view showing a concentrate container seated in a container support and ready for use.

### DETAILED DESCRIPTION OF THE PRESENT INVENTION

In the following description, the locational terms “above”, “below”, “higher”, “lower” are to be interpreted with respect to gravity and the normal installation wherein the container is installed in a beverage dispenser placed on its base.

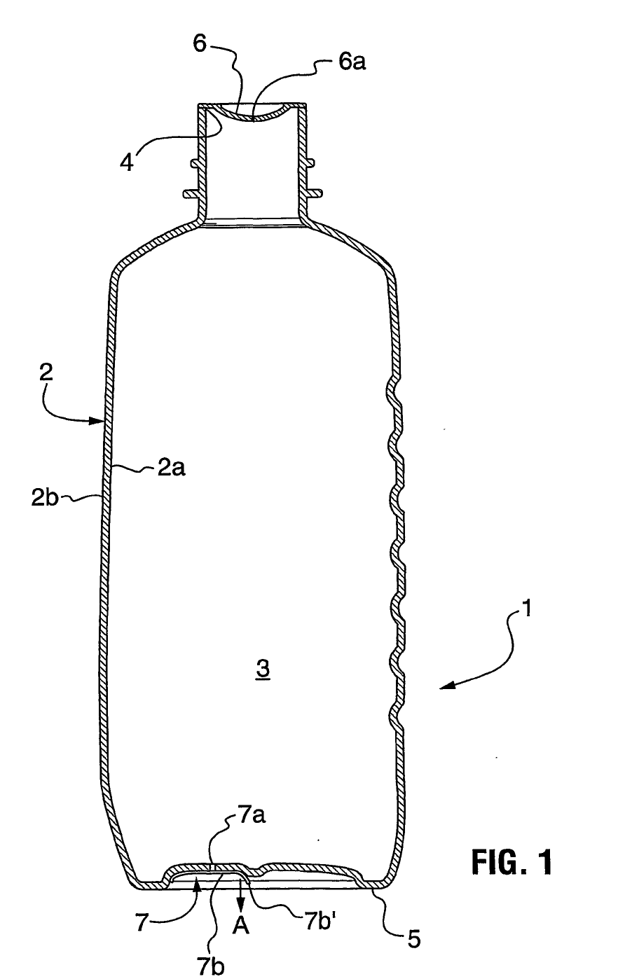

Referring to FIG. 1, a container 1 is shown for containing a beverage liquid such as for example, a juice or a juice concentrate. Container 1 includes a wall 2 having an inner surface 2a and an outer surface 2b and defining an inner chamber 3. An opening 4 in the wall provides access to the inner chamber. Container 1 is shaped as a bottle with opening 4 formed at the end of a necked portion and a base 5 formed opposite the opening. Container 1 can be formed in other shapes such as for example with two rounded ends, spherical, box shaped or box-shaped with tapered ends. However, the bottle shaped container is preferred for ease of handling and manufacture. The container can be formed of various materials. A thin, durable polymeric material such as PET is particularly useful. The container is preferably rigid enough to maintain its shape both when empty and when containing liquid.

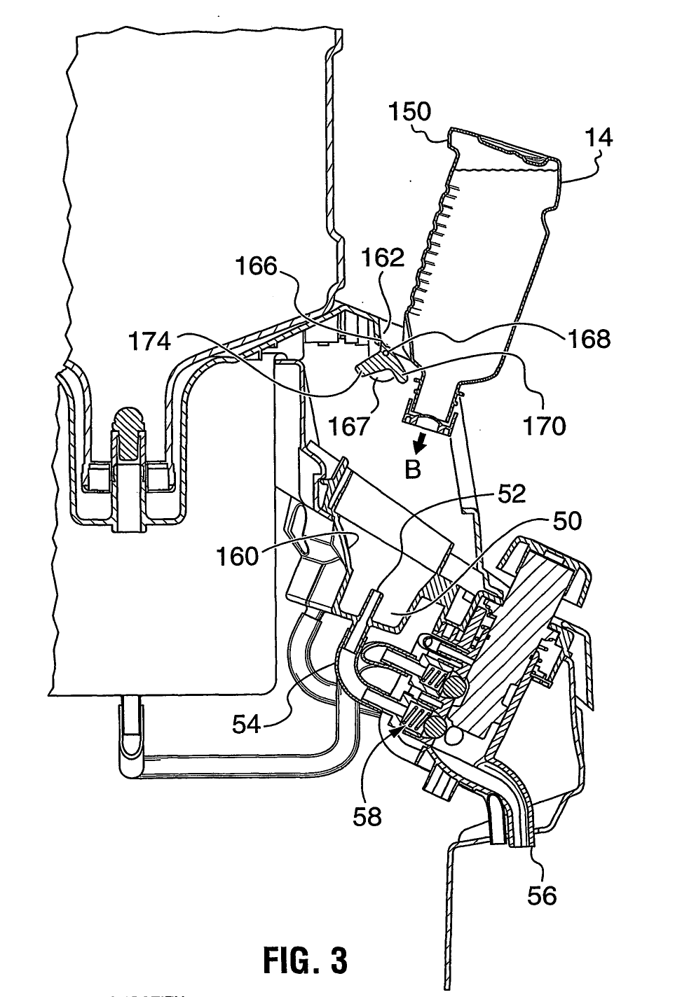

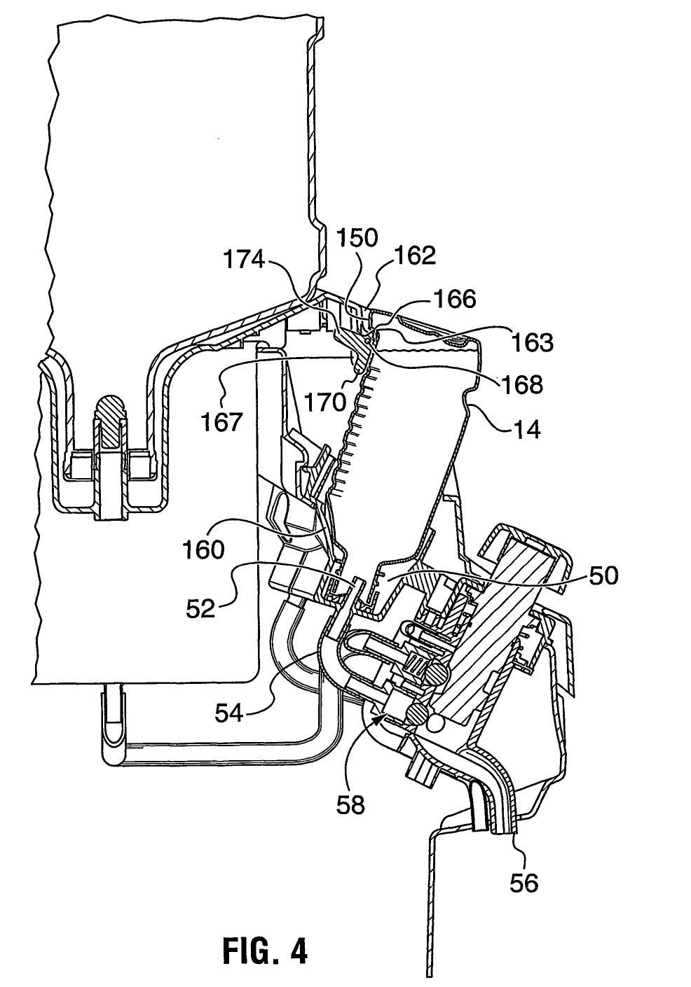

Opening 4 is formed to be installed over a feed tube pin in a beverage dispenser, as will be described in more detail hereinafter with reference to FIGS. 3 and 4. Generally, in operation, container 1 is installed over the feed tube pin with opening 4 positioned below base 5. To prevent free flow of liquid through the interface between the feed tube pin and the opening, a seal 6 is mounted over the opening. The seal can be mounted in various ways over the opening as by direct engagement, as shown, including fusing, welding or adhesives or by a mechanical clamping means such as by use of a cap or ring, which clamps the seal against the opening.

Seal 6 can be formed in any way to seal between the feed tube pin and the opening. In one embodiment as shown, seal 6 is formed of a water impermeable, elastomeric, food grade material, such as food grade rubber and includes a weak point 6a, which can be torn open by the feed tube pin but will flex to seal about the feed tube pin to minimize leakage therepast, once the feed tube pin is inserted therethrough and which will flex back to form a substantial seal over the opening once the feed tube is withdrawn from contact with the seal.

An openable area 7 is provided on the container, which is selectively openable to permit a passage of air therethrough into the inner chamber. The openable area must be provided to prevent an air lock when the bottle is installed for dispensing the beverage liquid contained therein. As such, the openable area is generally formed adjacent base 5, such that when the container is installed over the feed tube pin, the openable area is disposed in the air pocket above the liquid.

Openable area 7 in the illustrated embodiment, includes a port 7a and a removable seal 7b. Port 7a opens between inner surface 2a and outer surface 2b and is sized to permit passage of air into the inner chamber. Preferably, the port is of a size to permit adequate air flow, but to limit the size of items that can be passed therethrough for sanitary reasons. Port 7a can be formed by drilling, molding etc., as desired. Removable seal 7b is formed to seal over the port to prevent leakage of liquid therethrough, for example when the container is in transport or storage. In the illustrated embodiment, seal 7b is formed of a peelable film fused or adhered against the outer surface of wall 2. Seal 7b can be removed to expose and open port 7a by pulling, as shown by the arrow A, on a tab 7b′ of the seal. In another embodiment (not shown), the seal is a removable elastomeric plug engaged in the port and removable by pulling on a tab of the plug. In yet another embodiment, the seal is a puncturable, crackable or tearable film.

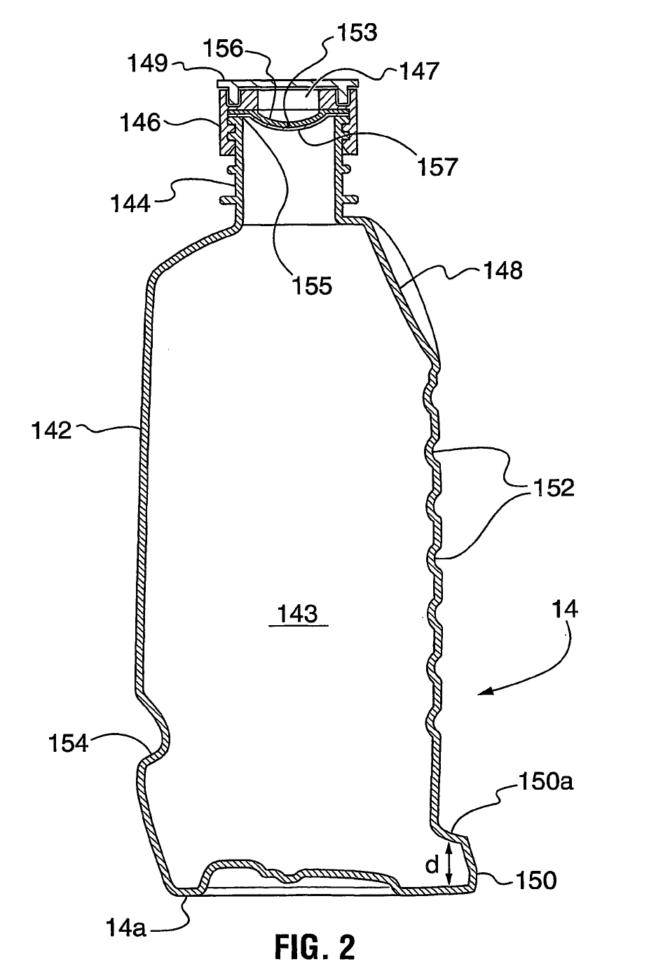

Referring to FIGS. 2 to 4, another container 14 is shown. Container 14 is useful to contain and dispense a beverage concentrate to a beverage dispenser having a concentrate container support arrangement 50 including a rigid feed tube pin 52. Container 14 includes a container body 142, defining an inner chamber 143, and a neck 144. The container can be formed of any material, such as polymeric material, glass or waxed cardstock, which can be formed into the desired shape. In one embodiment, the container is transparent and formed of the polymer PET, as is common for soft drink bottles, and as such the container is generally rigid to maintain its shape under normal use but can be punctured.

In the illustrated embodiment, container body 142 includes an indentation 148 formed adjacent neck 144.

A protrusion 150 is positioned adjacent container base 14a. In the illustrated embodiment, the protrusion is formed integral with the remainder of the container body and is of consistent thickness with the container body such that inner chamber 143 extends into the protrusion. Protrusion 150 is in the illustrated embodiment formed to be puncturable on its neck-facing surface 150a, as will be more fully described hereinbelow.

The container body can include ribs 152 and/or notches 154, as shown, or can be knurled or otherwise treated on its outer surface to facilitate secure grasping by a user. Ribs 152 also serve to enhance the crush resistance of the container over a flat surface.

Neck 144 includes an opening 155 at its upper end. Neck 144 is covered by an elastomeric seal 156, for example, formed of silicone. The seal includes a slit 153 and is flexible to permit feed tube pin 52 of the dispenser to pass therethrough. Slit 153 is, in this embodiment, always open but is formed such that the sides thereof remain closely positioned so that liquid substantially will not pass through the slit when no force is applied to the seal sufficient to open the slit. Generally, it is desirable that the force sufficient to open the slit be greater than the force exerted against the seal by the normal full volume of liquid in the container when the container is positioned with its neck below its base, such that in this position, minimal liquid, if any, will pass through the slit. A cross-shaped slit has been found to be particularly useful.

The seal is further selected to be resilient to conform or stretch about the feed tube pin to minimize liquid leaking through the opening past the feed tube pin. In addition, seal 156 is selected to substantially resume its original shape, with the edges of the slit closely positioned, once container is pulled off the feed tube pin to minimize liquid leakage therethrough.

Seal 156 is clamped over opening 155 by a cap 146 installed, as by threading over neck 144. An aperture 147 through cap 146 provides access to seal 156, once a protective lid 149 is removed. Lid 149 can be used to deter tampering and to protect seal 156 from soiling and damage and can be engaged on cap 146 in various ways such as by snap engagement, as shown. A puncturable liner 157, formed of foam, foil or film for example, is provided beneath seal 156 to prevent leakage through the slit and to show evidence of tampering. Of course, liner 157 could be positioned outwardly of seal 156, but may interfere, once punctured, with sealing of the slit.

Container 14 is intended for use with a beverage dispenser including a feed tube pin 52. In use, lid 149 is removed and container 14 is inverted such that neck 144 is positioned below base 14a. Container 14 is then inserted, neck 144 first (arrow B) into container support 50. Container support 50 is shaped to receive container 14 and is formed for easy cleaning and preferably is sized to contain much of the volume of a container, should a leak occur. In the illustrated embodiment, support 50 includes a raised portion 160 formed to mate with indentation 148 on the container. This prevents other containers, which are not intended to be used with the dispenser, to be mounted in container support 50 and ensures proper positioning of the container, when it is installed therein. Raised portion 160 and indentation 148, as shown, need not mate exactly.

The container support includes the rigid feed tube 52. As noted previously, feed tube 52 is formed to pass through seal 156 when the container is inserted thereover. As the container is brought towards the feed tube pin, the seal minimizes and preferably prevents any liquid from dripping out of the opening. When the seal comes into contact with the feed tube pin it is elastically deformed to seal about the pin as it passes therethrough.

When the feed tube passes through the seal, liner 157 is punctured by the feed tube pin. This gives a positive “popping” sensation indicative that the seal is seated over the feed tube.

The dispenser includes a cavity 162 into which protrusion 150 can rest. Cavity 162 includes a punch 166 which will puncture the container at the protrusion, thereby forming a port 163 through which air can flow to fill the container as the beverage drains through feed tube 52. Preferably the punch is positioned to puncture protrusion 150 on its downwardly facing side. This creates an opening that faces downwardly and is protected beneath protrusion from passage therethrough directly of contaminants dropping from above such as animal hair, dust or crumbs. The protrusion can be thinned to facilitate puncturing. However, the use of polymers such as PET permits puncturing without special treatment of protrusion, when compared to the remainder of the container body.

To avoid injury the punch can be recessed in cavity 162, until a container is inserted into the container support. In one such arrangement, punch 166 is mounted in a slot 167 in the cavity and is pivotally secured in slot 167 by a pivot pin 168. The member includes an end 170 that is safe for contact by a user. Punch 166 and end 170 are arranged about pivot pin 168 such that end 170 is normally biased to protrude into opening 48 and drive punch 166 to be recessed in the slot formed in cavity 162. However, when container 14 is inserted through the opening it contacts end 170 and drives the member to rotate about pin 168 to expose the punch in cavity 162. End 170 can be biased into the opening by a counterweight 174, as shown, or, for example, by including a spring (not shown) to act about the pivot pin.

It is to be noted that other punch arrangements can be used. As an example, the punch can be formed as a tube with a sharpened end. Using a tube punch, air tends to enter the container through the tube bore. A filter can be mounted in the tube bore to remove unwanted matter from the air as it passes into the container.

When container 14 is seated in the container support with feed tube pin extending up through the seal and the protrusion punctured by nesting in cavity 162, the beverage liquid contained in the container can drain through feed tube pin 52 and through a tube 54 into a nozzle 56 to be dispensed from the dispenser, as controlled by a valve 58. In the illustrated embodiment, the beverage liquid contained in container 14 is a concentrate intended to be mixed with water before consumption. FIGS. 3 and 4 illustrate only one embodiment of a beverage dispenser in which the container and container support can be used. Details of the beverage dispenser are not necessary for the understanding of the container and container support.

As beverage liquid drains from the container, air enters the container through the port formed by punch 166. Seal 156 seals about feed tube pin 52 minimizing, and preferably preventing, liquid leaking from the container into the container support.

Preferably, container support 50 and cavity 162 are formed and positioned such that when the container is installed therein, it is tilted to position protrusion 150 higher than any other part of the container. Thus, the air gap above the liquid is forced to be positioned in the protrusion and leakage through the punctured port is avoided.

The container can be removed from support 50 when it is empty and needs replacement or for other reasons such as, for example, during sanitization or repair of the dispenser. In removing the container from the support, the seal, being elastomeric, continues to seal against feed tube pin 52 as it is withdrawn from opening 155. Once the pin is completely withdrawn, the slit edges of the seal come together to resume the sealing position over the opening. Thus, in withdrawing the container, very little, if any, beverage leaks from the container into the container support.

Punctured port 163 is spaced from base 14a, such that container 14 can be placed on its base, without risk of residual liquid volumes, of generally less than 50 ml, leaking through the port. If larger volumes remain in the container, they can be emptied by removing cap 146. Alternately, the container can be maintained in an orientation that positions the air gap adjacent port 163.

It will be apparent that many other changes may be made to the illustrative embodiments, while falling within the scope of the invention and it is intended that all such changes be covered by the claims appended hereto.

1. A beverage container for use in a beverage dispenser having a beverage feed tube pin, the beverage container comprising: a wall having an outer surface and an inner surface and defining an inner chamber; an opening through the wall providing access to the inner chamber and sized to permit the feed tube pin to extend therethrough; a seal in the opening to substantially seal the opening against passage therethrough of liquid and selected to pass over the feed tube pin and substantially seal against passage of fluid through the interface between the opening and the feed tube pin, the seal further being selected to maintain its substantially sealing position in the opening as the feed tube pin is removed therefrom; and an openable area on the container, the openable area being selectively openable to permit a passage of air therethrough into the inner chamber.

2. The beverage container of claim 1 wherein the seal is resilient to resume its sealing position once the feed tube pin is withdrawn from the opening.

3. The beverage container of claim 2 wherein the seal is puncturable.

4. The beverage container of claim 2 wherein the seal includes a normally sealed opening therein.

5. The beverage container of claim 2 further comprising a puncturable liner in the opening.

5. The beverage container of claim 1 wherein the openable area is disposed on the wall at a base end of the container opposite the opening.

6. The beverage container of claim 5 wherein the openable area is spaced a selected distance from the base end of the container such that the volume of the inner chamber between the base end and the openable area is sufficient to accommodate the volume of residual liquid remaining in the container when it is deemed to be completely used.

7. The beverage dispenser of claim 6, wherein the volume is less than 50 ml.

8. The beverage container of claim 1 wherein the openable area includes a port through the wall and a removable or breakable seal over the port.

9. The beverage container of claim 8 wherein the port is oriented to open toward the opening.

10. The beverage container of claim 8 further comprising a protrusion extending outwardly from the outer surface thereof and the port being, positioned in association with the protrusion such that the port is positioned vertically below the protrusion when the container is installed over the feed tube pin.

11. The beverage container of claim 1 wherein the openable area is puncturable to form a port therethrough.

12. The beverage container of claim 11 wherein the port is oriented to open toward the opening.

13. The beverage container of claim 11 further comprising a protrusion extending outwardly from the outer surface thereof and the port being positioned in association with the protrusion such that the port is positioned vertically below the protrusion when the container is installed over the feed tube pin.

14. A beverage container support for supporting a beverage container including an opening for dispensing beverage therethrough and a base opposite the opening, the beverage container support comprising: a holder shaped to accept a beverage container; a feed tube pin extending upwardly in the holder and insertable into a beverage container to be supported; and a punch to puncture the beverage container when the beverage container is inserted over the feed tube pin and the punch spaced from the feed tube pin such that the punch acts adjacent the base of the beverage container.

15. The beverage container support of claim 14 wherein the punch is recessed and is driven out to puncturing position by installation of the beverage container to the support.

16. The beverage container support of claim 14 wherein the holder is sized to have a volume selected to substantially contain the volume of liquid in the container.
